(19) United States
(12) Patent Application Publication
(10) Pub. No.: US 2012/0158548 A1
(43) Pub. Date: Jun. 21, 2012

(54) METHODS AND SYSTEMS FOR MANAGING RETAILER VIRTUAL STORES

(75) Inventor: Lenard William Conlon, Fountain Hills, AZ (US)

(73) Assignee: AYR1, Inc., Scottsdale, AZ (US)

(21) Appl. No.: 12/974,680

(22) Filed: Dec. 21, 2010

(51) Int. Cl. G06Q 10/00; G06Q 30/00

(52) U.S. Cl. 705/27.1

(57) ABSTRACT

A computer-implemented method is provided for managing retailer virtual stores for a plurality of retailers. Each of the retailer virtual stores displays products from one or more product providers available for sale to consumers. The method includes the steps of: receiving from each of the plurality of product providers data describing products available from the product provider; receiving from each of the plurality of product providers or representatives of the product providers an indication as to whether a retailer has permission to display a given product from the product provider; populating each of the retailer virtual stores with products selected by respective retailers and permitted to be displayed in the virtual store by product providers or representatives of the product providers; and periodically receiving from product providers changes to data on their products, and automatically updating product data in retailer virtual stores reflecting the changes.

### BACKGROUND

The present application relates generally to retailer virtual stores and, more particularly to, methods and systems for managing such stores.

### BRIEF SUMMARY OF THE DISCLOSURE

In accordance with one or more embodiments, a computer-implemented method is provided for managing retailer virtual stores for a plurality of retailers. Each of the retailer virtual stores displays products from one or more product providers available for sale to consumers. The method includes the steps of: receiving from each of the plurality of product providers data describing products available from the product provider; receiving from each of the plurality of product providers or representatives of the product providers an indication as to whether a retailer has permission to display a given product from the product provider; populating each of the retailer virtual stores with products selected by respective retailers and permitted to be displayed in the virtual store by product providers or representatives of the product providers; and periodically receiving from product providers changes to data on their products, and automatically updating product data in retailer virtual stores reflecting the changes.

In accordance with one or more further embodiments, a retailer virtual store management system is provided. The system is accessible by product providers over a communications network. The system includes a plurality of retailer virtual stores, each provided to one of a plurality of retailers for displaying products from one or more product providers available for sale to consumers. The system also includes a plurality of content management systems, each provided to one of the product providers for enabling the product provider or a representative of product provider to control which of its products can be displayed in which of the retailer virtual stores. The content management system also allows the product provider to periodically provide product information changes, and to automatically update product data in retailer virtual stores reflecting the changes.

In accordance with one or more further embodiments, a computer-implemented method is provided for operating retailer virtual stores for a plurality of retailers. Each of the retailer virtual stores displays products from one or more product providers available for sale to consumers. The method includes the steps of: receiving from each of the plurality of product providers data describing products available from the product provider; populating each of the retailer virtual stores with products selected by respective retailers; periodically receiving from product providers changes to data on their products, and automatically updating product data in retailer virtual stores reflecting the changes; and collecting data on consumer activity in retailer virtual stores and providing the data to product providers.

In accordance with one or more further embodiments, a retailer virtual store management system is provided that is accessible by product providers over a communications network. The system includes a plurality of retailer virtual stores, each provided to one of a plurality of retailers for displaying products from one or more product providers available for sale to consumers. The system also includes a plurality of content management systems, each provided to one of the plurality of product providers for enabling product providers to manage data on their products in retailer virtual stores. The content management systems allow product providers to periodically provide product information changes, and to automatically update product data in retailer virtual stores reflecting the changes. The content management systems also allow product providers to access data on consumer activity in retailer virtual stores.

Various embodiments of the invention are provided in the following detailed description. As will be realized, the invention is capable of other and different embodiments, and its several details may be capable of modifications in various respects, all without departing from the invention. Accordingly, the drawings and description are to be regarded as illustrative in nature and not in a restrictive or limiting sense, with the scope of the application being indicated in the claims.

### BRIEF DESCRIPTION OF THE DRAWINGS

FIG. 1 is a simplified block diagram illustrating a retailer virtual store management system in accordance with one or more embodiments.

FIG. 2 is a screenshot of an exemplary table used by product providers for adding catalog items.

FIG. 3 is a screenshot of an exemplary table used by product providers for allowing particular retailers to display specific catalog items.

FIG. 4 is a screenshot of an exemplary table used by product providers to accept or reject a retailer's request to feature a product provider's catalog.

FIG. 5 is a screenshot of an exemplary table used by product providers to assign product provider representatives to particular retailers.

FIG. 6 is a screenshot of an exemplary table used by product providers for managing representatives.

FIG. 7 is a screenshot of an exemplary table showing buyer inquiry information provided to product providers.

FIG. 8 is a screenshot of an exemplary table showing month-by-month buyer inquiry tallies of retailers for a specific catalog.

FIG. 9 is a screenshot of an exemplary table showing month-by-month tallies of buyer inquiries for specific catalog items across all retailers.

FIG. 10 is a screenshot of an exemplary table showing buyer inquiries for specific catalog items.

FIG. 11 is a screenshot of an exemplary table allowing product providers to view buyer inquiries relating to the particular retailer.

FIG. 12 is a screenshot of an exemplary page allowing product providers to specify warranty information.

FIG. 13 is a screenshot of an exemplary table allowing product providers to specify whether the warranty information entered in FIG. 12 applies to particular catalog items.

FIG. 14 is a table showing exemplary data sets that can be used for custom reports.

FIG. 15 is a screenshot of an exemplary table showing traffic data per catalog item across retailers.

FIG. 16 is a screenshot of an exemplary products special features management page.

FIG. 17 is a screenshot of an exemplary table for editing special features.

FIG. 18 is a screenshot of an exemplary page allowing special feature attributes to be set for specified products.

FIG. 19 is a screenshot of an exemplary table allowing product providers to manage features for products.

FIG. 20 is a screenshot of an exemplary page allowing product providers to define additional features for products.

FIG. 21 is a screenshot of an exemplary table allowing product providers to associate features with products.

FIG. 22 is a screenshot of an exemplary spreadsheet allowing product providers to load product information in bulk.

Like or identical reference numbers are used to identify common or similar elements.

### DETAILED DESCRIPTION

As used herein, the term “product provider” is intended to broadly refer to any supplier of products to retailers including, without limitation, manufacturers making or assembling the products as well as companies like wholesalers distributing the products to retailers.

Various embodiments disclosed herein are directed to a retailer virtual store management system that hosts and manages retailer virtual stores for multiple retailers. The retailer virtual stores display products from one or more product providers, and can be accessed by consumers online, typically through individual retailer websites. Consumers use the retailer virtual stores to obtain information and/or make purchases of products from retailers. The system obtains data on products from product providers and uses the data to populate retailer virtual stores. When a product provider updates or otherwise changes data for a given product, the system receives the updated data from the product provider and automatically changes the corresponding product information in retailer virtual stores carrying the product. Thus, retailers are assured have current information on products displayed in their virtual stores.

As will be discussed in further detail below, product providers can use a content management system to selectively control which of their products can be displayed in which retailer virtual stores. If, e.g., a product sold by a product provider is exclusive to certain retailers, the product provider can prevent other retailers from displaying that product in their virtual stores. In accordance with one or more further embodiments, product provider representatives can also exercise control over products displayed in retailer virtual showrooms.

In accordance with one or more further embodiments, the system collects data on consumer activity in retailer virtual stores, and provides such information to product providers, their representatives, and retailers. For example, product providers and their representatives have access to data on buyer inquiries received at retailer virtual stores. Product providers can see buyer inquiry data relating to their products from multiple retailer virtual stores. Product providers can also see the level of buyer inquiry activity per retailer, and can use this information to advise retailers on what products to carry. Product providers can also see the total buyer inquiry volume of products across product providers to determine their respective market share. Information on buyer activity is preferably segregated such that product providers do not have detailed information on buyer activity related to products of other product providers.

In accordance with one or more further embodiments, the system generates reports for product providers and their representatives relating to views of their products including, e.g., the number of views, which retailers have had views, maps of where views occurred. Other information can also be gathered such as, e.g., information on the computer used by the consumer to access a retailer virtual store, including the type of browser, type of computer operating system, or computer display resolution. Product providers can view information from multiple retailer virtual stores. Information is preferably filtered so that product providers do not have access to information on specific customers.

In addition to product providers, their representatives, and retailers, data on consumer activity can be provided to other users such as retailer associations and product provider consultants. Retailer associations such as buying groups can use the data to help retailers choose what products to sell. Product provider consultants can also use the data to provide product providers with a variety of information including, e.g., what types of products are being sold and the market share of a product provider.

The system also provides a content management system for retailers, which can be used by retailers to control and manage their virtual stores. Retailers can receive buyer inquiries through the content management system and automatically assign inquiries to particular sales employees.

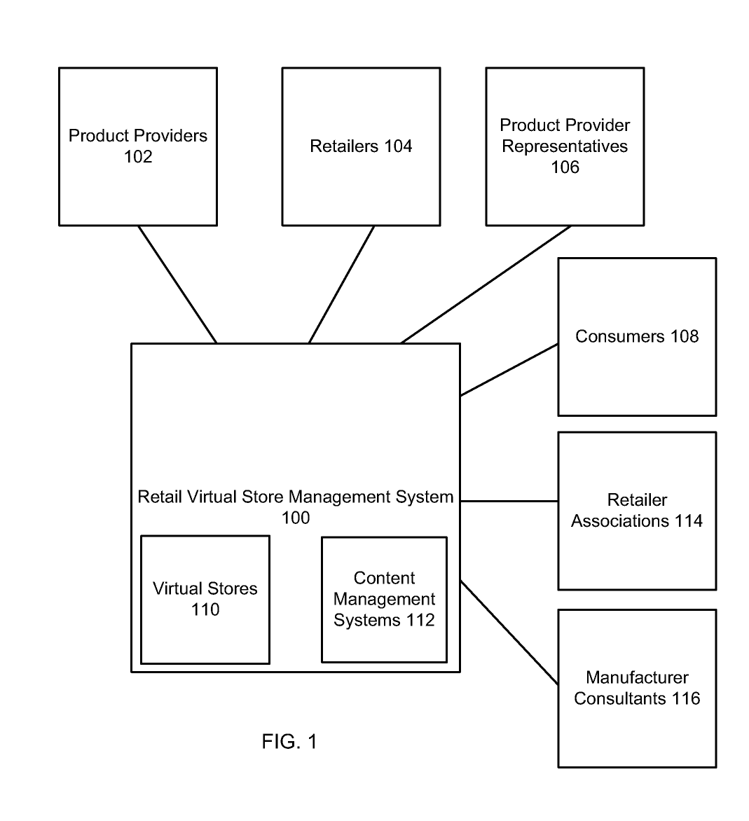

FIG. 1 is a simplified block diagram illustrating operation of a retailer virtual store management system in accordance with one or more embodiments. The system 100 can be implemented in a computer server system and accessed by client devices operated by product providers 102, retailers 104, product provider representatives 106, consumers 108, retailer associations 114, and manufacturer consultants 116. The client devices can access the system 100 over a communications network. The network may be any combination of networks, including without limitation the Internet, a local area network, a wide area network, a wireless network, and a cellular network. The client devices can comprise a variety of computing devices including personal computers and portable communications devices such as smart phones. The computer server system may comprise one or more physical machines, or virtual machines running on one or more physical machines. In addition, the computer server system may comprise a cluster of computers or numerous distributed computers that are connected by a network.

As discussed in further detail below, the system 100 hosts virtual stores 110 for retailers containing products from the product providers. The system 100 also provides content management systems 112 allowing retailers, product providers, and product provider representatives to manage the virtual stores.

Consumers can access virtual stores using their own client devices from generally any location. Alternately, consumers can access the retailer virtual stores from a retailer computer within a physical retailer store.

In the various examples provided below illustrating use of the system 100, the products described are furniture items. It should, however, be understood that the system can be used for generally any type of products sold to consumers.

### Retailer Virtual Stores

Retailer virtual stores can be accessed by consumers typically through retailer websites. Each virtual store includes a homepage typically containing the retailer's motto, a store description, and navigation links associated with the site. The bottom of the homepage can include descriptive content to improve search engine ranking. A sitemap can also be included to help search engines index the pages of the virtual store.

Each retailer virtual store includes a showroom used to display products offered for sale by the retailer. The showroom can be divided into categories and subcategories to make it easier for customers to find desired products. In addition, the virtual store can include catalogs organized by brand to allow consumers to shop for products by selected brands. Virtual stores can also include search features, allowing customers to search an entire virtual store by keywords to find desired products.

Retailer virtual stores can also include links to product providers of particular products displayed in a virtual store.

Retailer virtual stores can be accessed by consumers from virtually any location using their own client devices. In addition, consumers can access a retailer's virtual store using a computing device provided by the retailer within a physical store. A retailer can thus use its virtual store to show products to consumers that the retailer can supply, but are not present in the physical store. Virtual stores allow retailers to avoid use of printed catalogs, which can be expensive and are often quickly outdated.

The system allows consumers to submit buyer inquiries to request further information on a product during a visit to a retailer virtual store. Buyer inquiries received by the system are sent to an email account of the retailer and also saved in the Customer Relation Management (CRM) system for the retailer. Using the CRM system, retailers can manage disposition of buyer inquiry leads to their sales staff, control closing ratios, and monitor sales. Retailers can use buyer inquiry data to identify shopping patterns by day, by time, and even geographically. The system can also compile an e-mail list of buyers, which retailers can use to send advertized promotions to consumers who have consented to receiving such promotions.

By way of example, the system can capture the following information in a buyer inquiry: customer name, e-mail address, phone number, city of residence, and zip code, customer comments, and product information including SKU number and product manufacturer.

### Management Tools for Product Providers

The system provides product providers with a content management system that allows product providers to quickly and easily control their inventory, get product information to consumers, and obtain Web traffic information specific to their products. Product providers can use their content management systems to add, remove, and manage their catalogs in retailer virtual stores.

Product providers can also manage product warranties displayed with their products. Warranties can be product specific and can be in the form of a file that can be uploaded on the retailer's virtual store in PDF and other file formats.

Product providers can also use their content management systems to add and manage product videos to help consumers better understand the features and benefits of their products.

In addition, product providers can use their content management systems to identify and manage product relationships, which can be used by retailers to increase sales of related products.

The content management system also allows product providers to manage product attributes. Categorizing products by attributes allows consumers to more readily find particular products by identifying their attributes. Some examples of product attributes for a furniture item can include back type, arm type, show wood, solid wood, and wood type.

The content management system also allows product providers to control the inventory in each retailer virtual store. As discussed above, this feature is particularly useful when a product sold by a product provider is exclusive to certain retailers, making it important that other retailers not be able to display that product.

The system also provides content management systems that can be used by product provider representatives to control the inventory in each of their assigned retailer virtual stores. Product providers can use their content management systems to assign representatives who can access particular retailer virtual stores.

Product providers can also use their content management systems to manage buyer inquiries. The content management system allows product providers to see which retailers are getting inquiries on which product and from where. Product providers can also see the total inquiry volume of products across product providers to determine their respective market share.

Product providers can also use their content management systems to manage their product views. Specifically, product providers can see how often consumers are looking at their products, which retailers are getting the most views and on what products, where these views are coming from, at what time of day, and other analytic data.

Product providers, their representatives, and retailers can access their respective content management systems using a web browser. Access to content management systems is restricted to authorized users, e.g., through password protection.

The content management system for each product provider includes a product provider control center, which product providers can use to manage products shown in retailer virtual stores. The manage product section of the control center allows a product provider to add or edit catalog contents item by item.

When adding a new item, a product provider can input the following: (1) a collection name if the item is part of the collection. (A collection is a division within a catalog, e.g. ‘Louis Phillip Collection’); (2) a product name; (3) an SKU number or other unique product identifier; (4) in item description (e.g., ‘romance’ text that defines a product and illustrates its features); (5) item dimensions (with choice of metric or imperial measurement); (6) product style; (7) product category (The category can be chosen from, e.g., a pull down menu containing possibly hundreds of categories and subcategories, corresponding to the dynamic ‘shop by category’ menu used by consumers in retailer virtual stores; and (8) a picture/line drawing (in JPEG, PDF, and other file formats).

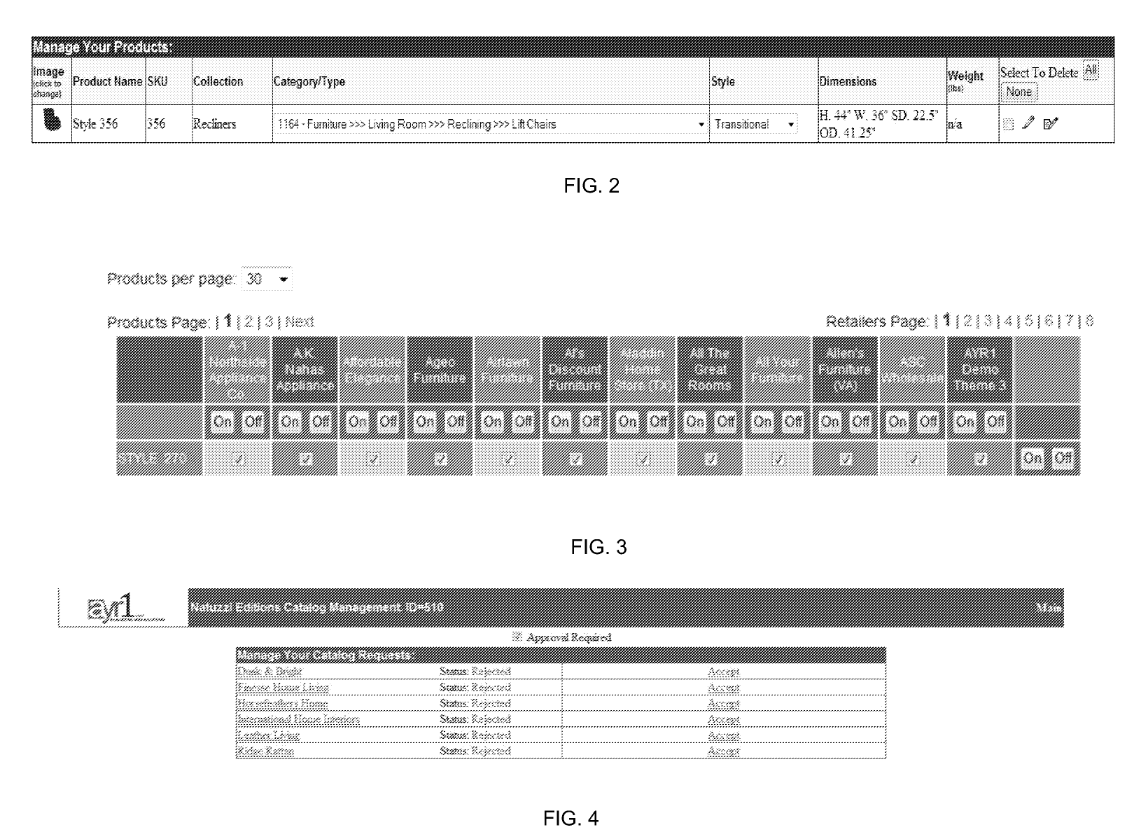

Added products can be shown to a content management system user in table form as shown, e.g., in FIG. 2. The columns of the table can include a thumbnail image of the item, product name, SKU, collection, category/type, style, dimensions, and weight. The last column enables the user to select the item for deletion. Users can select/unselect all items on the immediate page using the ‘All’ and ‘None’ buttons in the column's header. Items can be deleted by clicking the ‘Delete’ button beneath the table. Items can be edited by clicking on the pencil icon or an item's special features can be edited by clicking the pencil or paper icon.

Multiple products can appear in the table, e.g., 50 at a time, and the user can jump from page to page via the page links beneath the table.

Contents of the table can be pared down and isolated via pull down menus and switches above the table, either by major category (furniture, home accents, etc.), minor category/type, or collection. A user can also search for an individual item in the table (e.g., by product name or SKU), or sort the items in the table (e.g., by product ID, product name, category collection, or model number).

### Catalog Management

The system provides a notification, e.g., by e-mail, to a product provider whenever a retailer adds the product provider's catalog to the retailer's virtual store.

The product provider can manage its catalogs and representatives in the following ways:

A product provider can allow particular retailers to display specific catalog items, or deny them from doing so. As shown in the exemplary table of FIG. 3, items are displayed in the table by row, and retailers are displayed by column. Intersecting cells can be individually checked/unchecked, or whole rows/columns can be checked/unchecked by toggling the on/off buttons on the headers.

Multiple (or all) catalog items can be displayed at a time based on user preferences or a specified default number of items.

A product provider can allow particular retailers to display the entire catalog. The product provider can also deny the entire catalog to other specified retailers.

If a product provider previously selected an ‘Approval Required’ box in the product provider control center, retailers cannot add the product provider's catalog to their virtual stores without the product provider's approval. FIG. 4 is an example of a table that can be used by a product provider to accept or reject a retailer's request to feature the product provider's catalog.

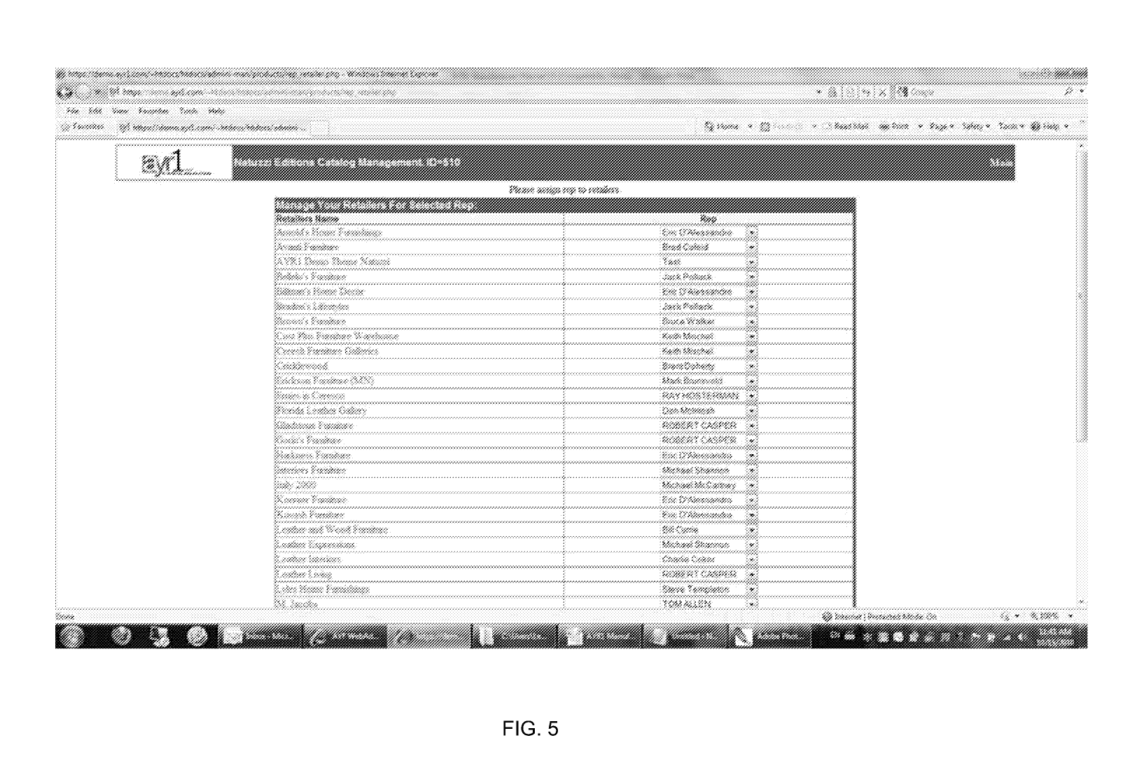

Product providers can assign product provider representatives to particular retailers using the exemplary table shown in FIG. 5 via a pull-down list. This provides the representative access to their assigned retailer catalogs and gives them access to traffic data and buyer inquiries data through their own content management system tools.

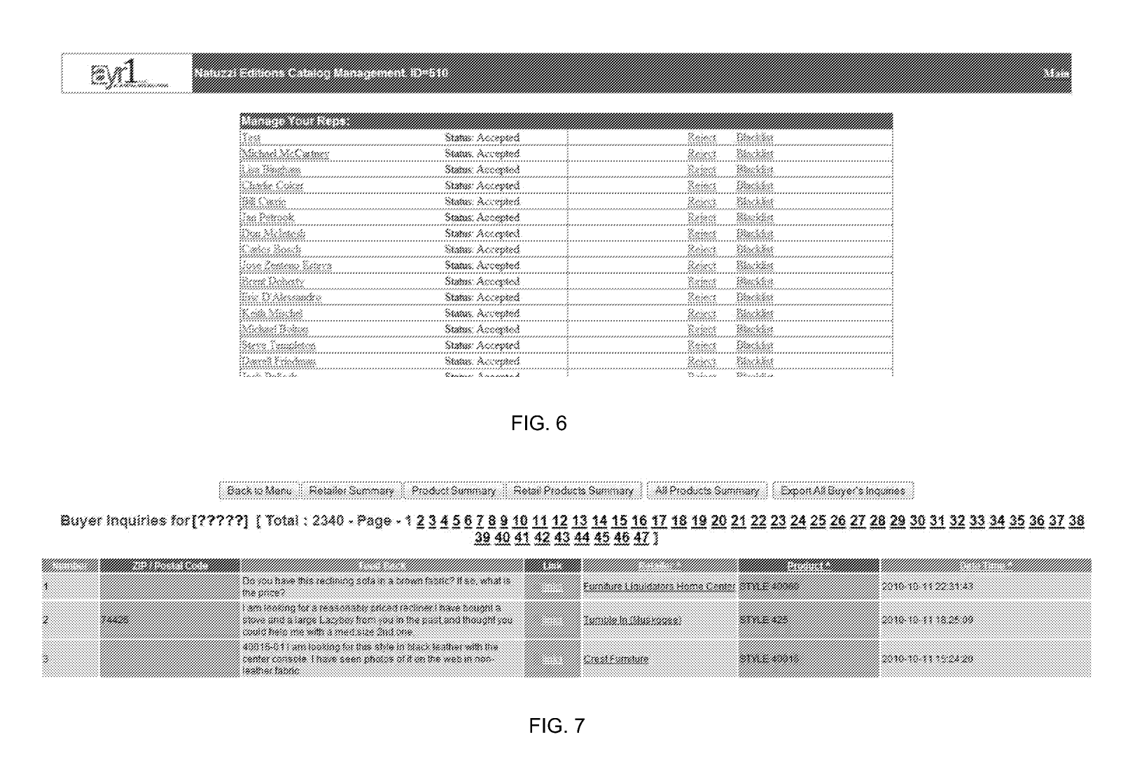

Product providers can use the exemplary table of FIG. 6 to obtain a Product provider representative's contact information, or status, and to accept/reject/blacklist them from the system.

The product provider control center allows product providers to easily view their catalogs by pressing a button providing a direct link to the catalog as the retailer's customer sees it in the ‘Shop by Brand’ area of a virtual store.

### Buyer Inquiry Reporting

The product provider control center allows product providers to view inquiries made by consumers at retailer virtual stores. FIG. 7 is an exemplary table showing buyer inquiry information provided to product providers. The columns within the table display the ZIP Code of the customer, the customer query, a clickable link to the catalog item in the retailer's virtual store, the retailer name, the product name, and the date and time the inquiry was received. This list can be sorted by retailer, product, or date received. Multiple items (e.g., 50) can be shown at a time.

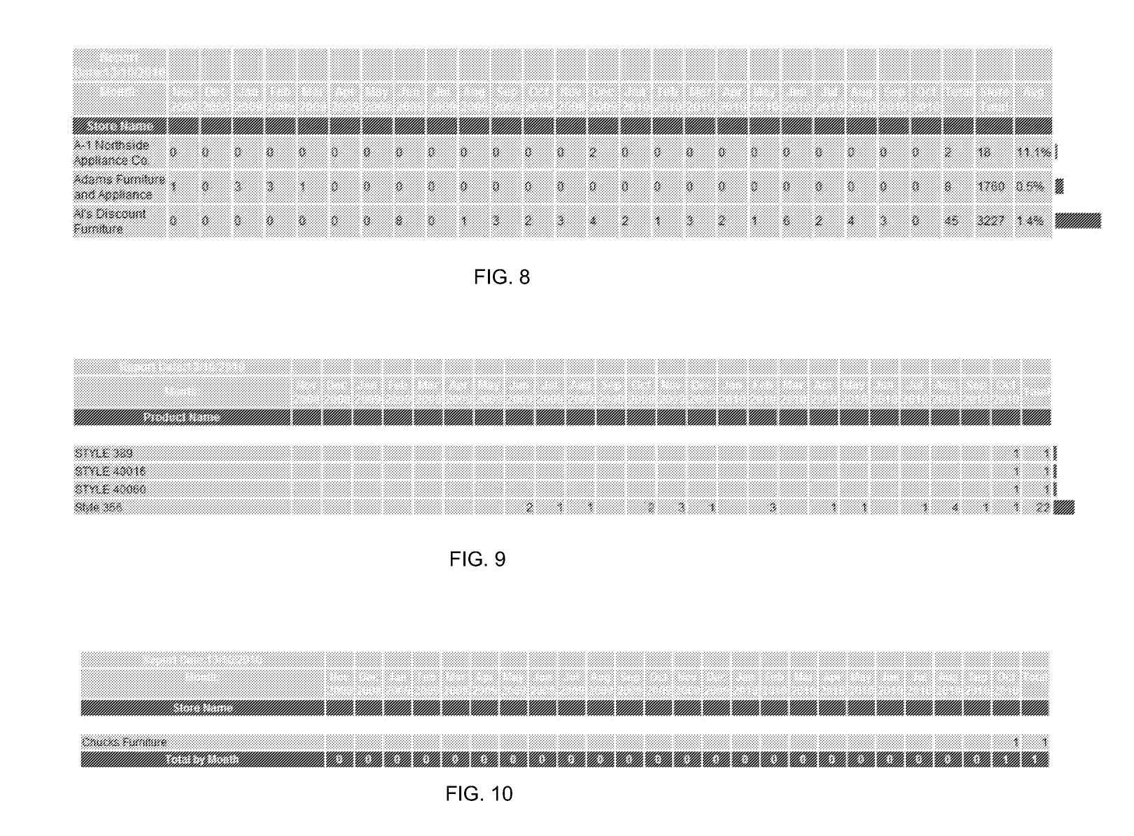

The product provider control center provides various reporting tools for analyzing buyer inquiry data collected by the system. For example, FIG. 8 illustrates a table showing month-by-month buyer inquiry tallies of retailers for a specific catalog. The table can cover a specified time span, e.g., two years prior to and including the present. The retailers can be arranged alphabetically. In addition, the table entries can be sorted. The up/down arrows for individual months allow a ‘greatest to least’/‘least to greatest’ quantity sort.

The last four columns of the exemplary table display the total number of buyer inquiries for each retailer on this catalog, the store total on all catalogs, the percentage of inquiries for this catalog against all other catalogs, and a bar chart to allow users to more easily identify the top performers.

FIG. 9 illustrates an exemplary table showing month-by-month tallies of buyer inquiries for specific catalog items across all retailers.

FIG. 10 illustrates an alternative exemplary table showing buyer inquiries for specific catalog items. In this case, a user initially selects a specific catalog item from a pull-down list. The resulting table displays month-by-month tallies of buyer inquiries referencing that specific item.

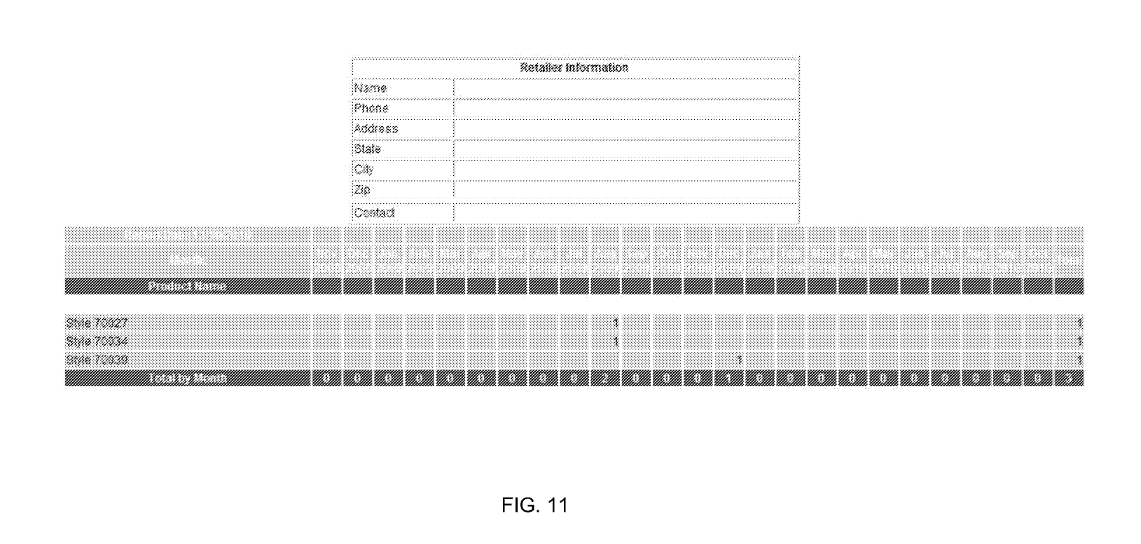

FIG. 11 illustrates an exemplary table allowing a product provider to view buyer inquiries relating to the particular retailer. The product provider is able to select a specific retailer carrying its catalog from a pull-down list. The resulting table displays the retailer's address, phone number, and contact, and month-by-month buyer inquiries for specific catalog items for that retailer.

Product providers are also able to obtain data on buyer inquiries on all catalog products. The data can be presented in table containing month-by-month tallies of buyer inquiries for individual catalog items over a given period, e.g., the two-year period preceding the present.

Product providers can export tables containing buyer inquiry data into various file formats including, e.g., .csv file formats.

Product providers can save the list of retailers carrying their catalogs in a file format such as a .csv or .xls file. The file can contain the retailer name, address, city, province/state, country, main phone number, and the email address where the retailer receives its buyer inquiries.

### Product Warranties

Product providers can also specify warranties for their products shown in virtual showrooms. The system allows product providers to specify a warranty (by name, description, terms, and price), as well as append a document outlining the warranty terms, and establish whether it is immediately applicable via an ‘Active/Inactive’ switch. This can all be applied to one or multiple catalog items.

The product provider control center can display all created warranties in a table with the ability to filter out inactive warranties and duplicate warranties via check boxes.

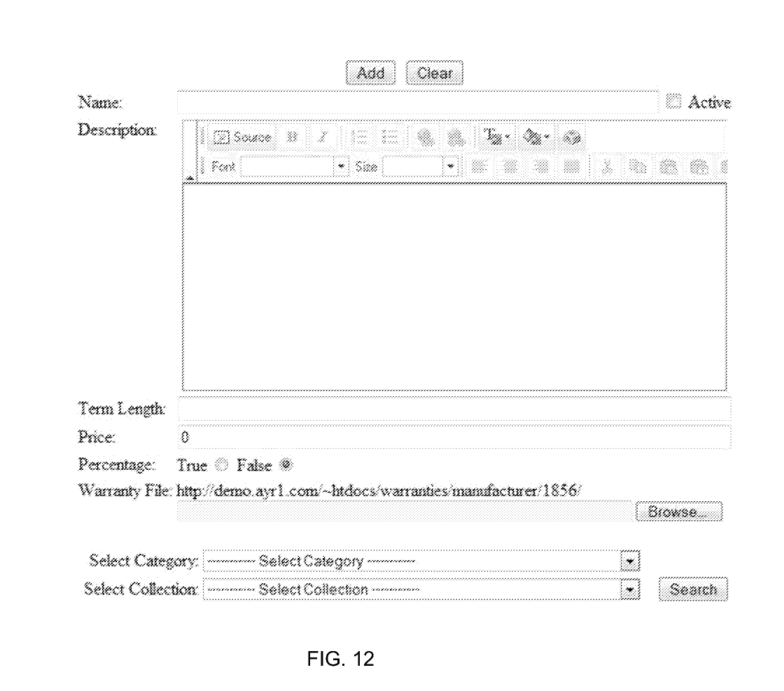

Clicking an ‘Add Warranty’ button at the table brings the user to a new page shown by way of example in FIG. 12 with fields where warranty details can be input, including warranty name, ‘Active’ switch, description, term length and price, percentage, and warranty file. An attribute pull-down list can be used to select the categories or collections to which the warranty will apply.

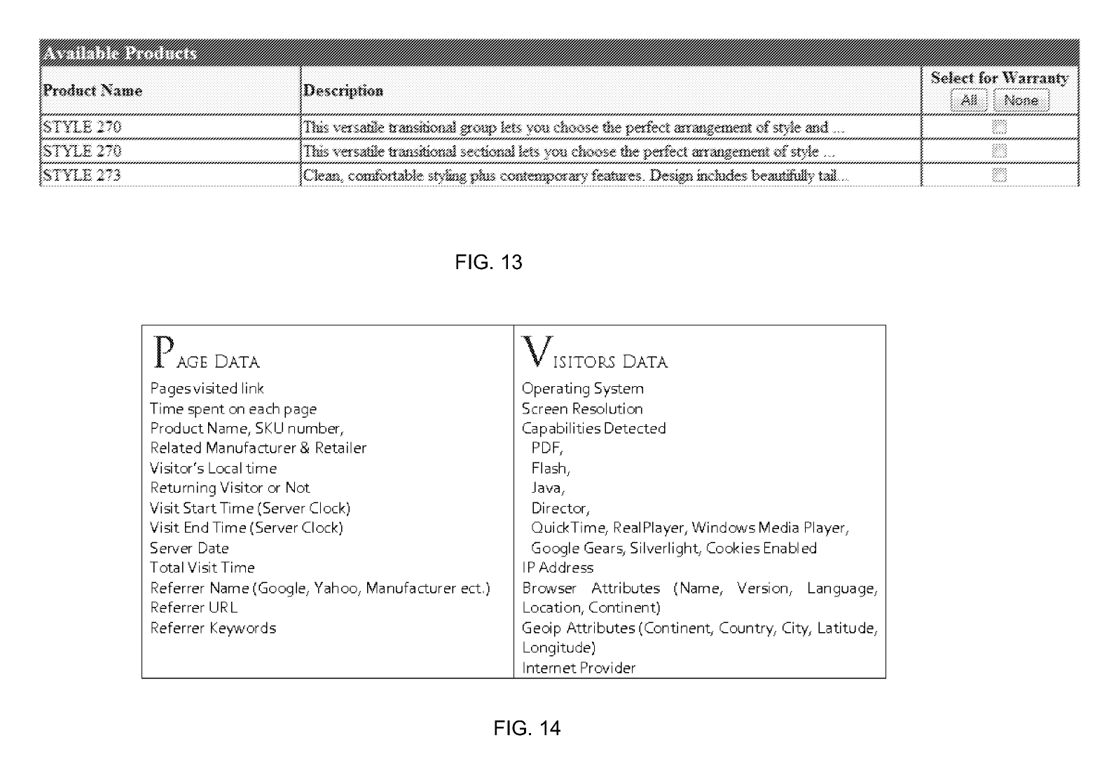

FIG. 13 illustrates an exemplary table featuring all the catalog items, with columns ‘Product Name’, ‘Description’, and ‘Select for Warranty’ with a check box allowing the user to select whether the warranty entered in FIG. 12 applies to that specific catalog item. ‘All/None’ toggle buttons enable the filling/unfilling of all check boxes in the ‘Select for Warranty’ column. ‘Add’ and ‘Clear’ buttons enable a user to either save the warranty or clear all the fields and start over.

### Product Views

The product provider control center allows product providers to view the product traffic that retailers have received on their catalog items. FIG. 14 is a table showing some of the data sets that can be used for custom reports.

An example of the use of traffic data is demonstrated in the table of FIG. 15. This table shows the total number of views per catalog item for all of retailers using this catalog in their virtual stores, sorted by month.

### Special Features

Product providers can also use the product provider control center to manage additional features. For instance, a product provider can define special features that correlate with filters retailers may have for catalog items in their virtual stores. Special features are specific details about products. For example, for furniture items such details may include upholstery type, material type, number of drawers, etc.

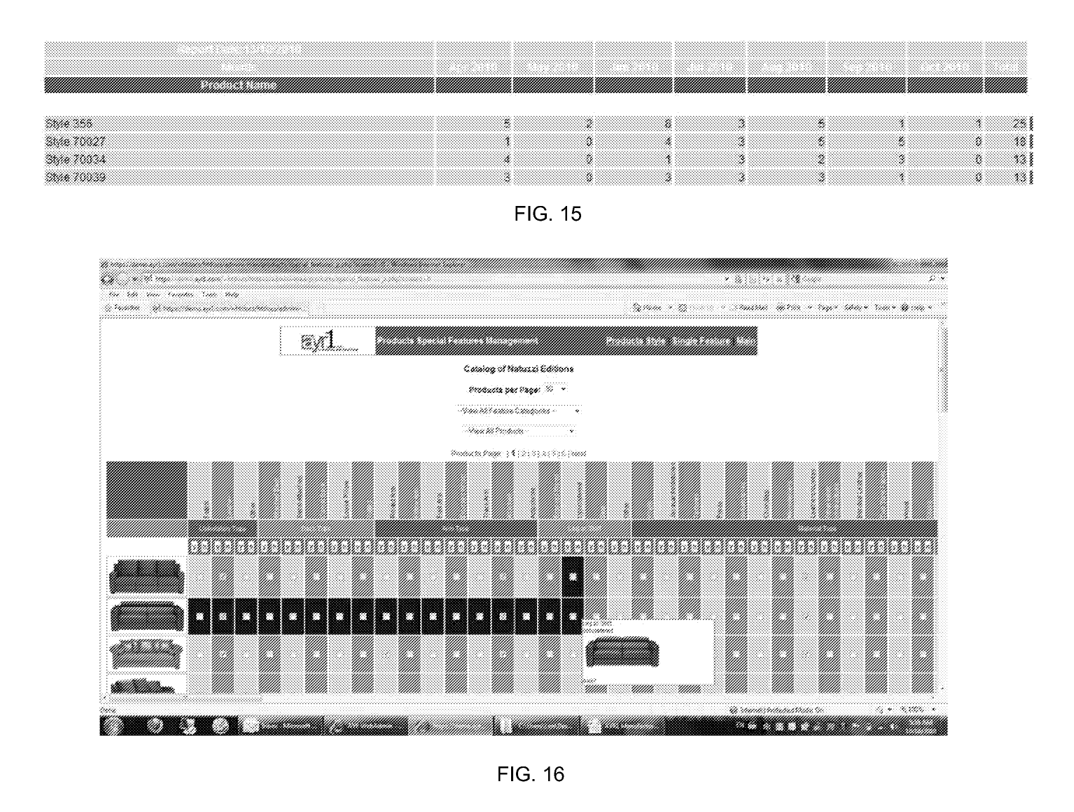

FIG. 16 shows is a screenshot of an exemplary products special features management page, which allows users to define special features. The ‘Product Style’ features are shown by default. The pull-downs at the top of the page enable users to edit multiple items (e.g., 30, 50, 100, or all items) at a time. The pull-downs also enable users to filter out catalog items by category, and filter out items that have features or do not have features.

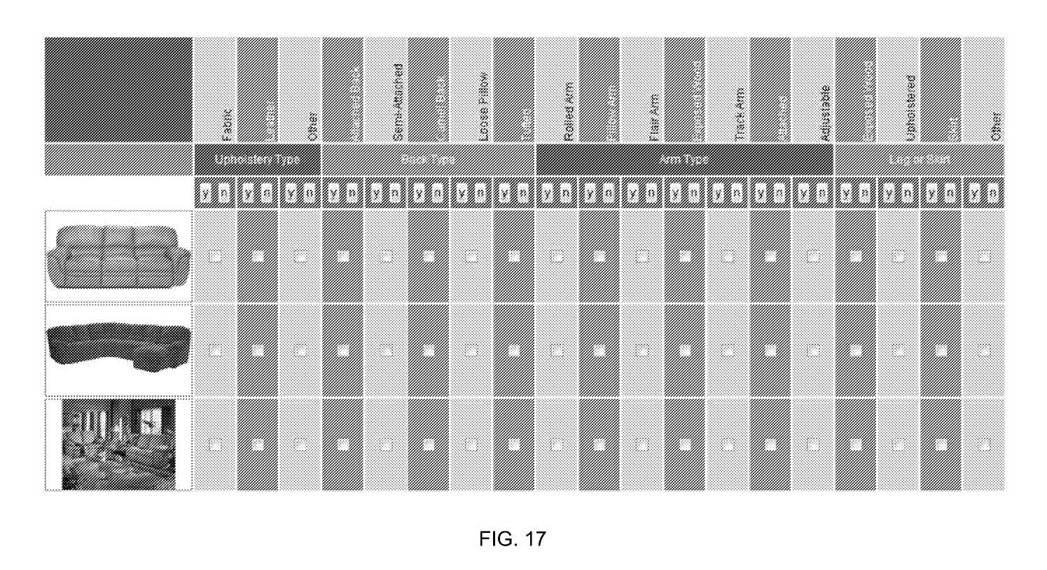

FIG. 17 illustrates an exemplary table for editing special features. The rows of the table contain individual catalog items, and are identified by their thumbnail image. Hovering over the image will cause it to expand and an alt tag will appear with additional product detail. The check boxes allow the selection of special feature attributes for this product. ‘Y/N’ switches at the header and footer of each column allow the selection/de-selection of all check boxes within it.

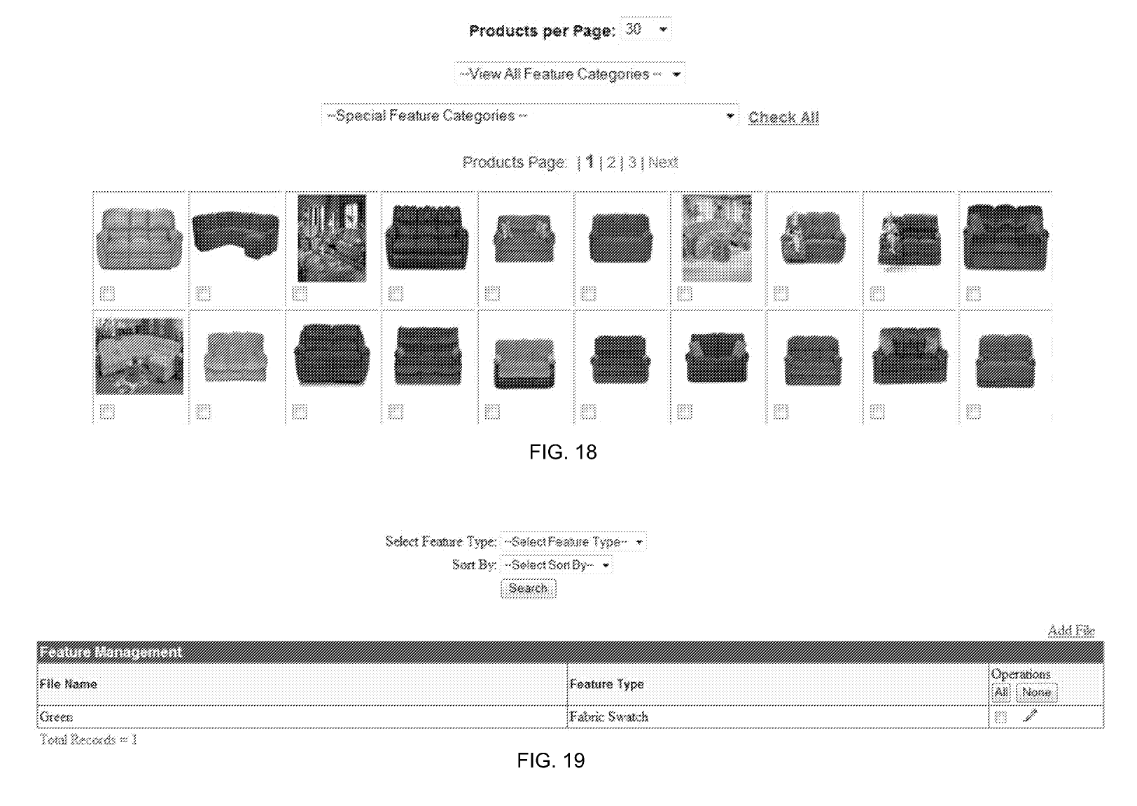

FIG. 18 illustrates an example of how special feature attributes can be set for a specified product. Selecting ‘Special Feature Categories’ in a pull-down enables the user to isolate a specific special feature to apply to the thumbnail images of various products.

The product provider control center also allows product providers to manage additional features. For instance users can apply assembly instructions, fabric swatches, video and audio to specific or multiple catalog items.

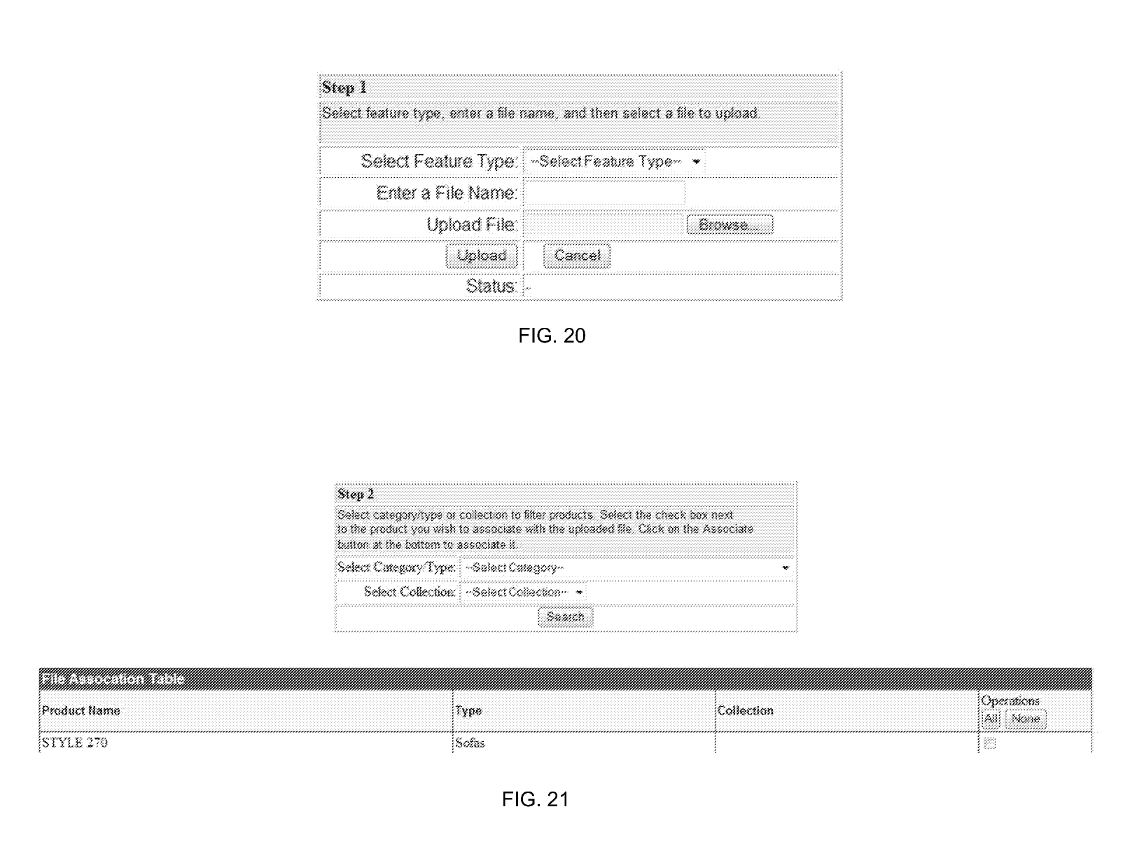

The main area of the control center can also include a table (e.g., as shown in FIG. 19) listing these features by file name, feature type, and operations, beneath which are check boxes that enable deletion of listed features. ‘All/None’ buttons can toggle/un-toggle all the check boxes in the column, and a pencil icon to the right of each check box enables a user to edit details of its associated feature. Two pull-downs above the table enable the user to filter out other additional features in favor of the chosen one, or sort the items in the table by file name or feature type. The ‘Add File’ link on the top right takes the user to a new page as shown, e.g., in FIG. 20, containing fields that define a new feature, specifically a ‘Select Feature Type’ pull-down, a ‘File Name’ field, and a place to upload the file, followed by a ‘Status’ field that displays the success/failure of the file's having been uploaded.

Beneath these fields are the catalog items as shown in the exemplary table of FIG. 21. Multiple items (e.g., 50) are displayed at a time in the table, with ‘Product Name’, ‘Type’, and ‘Collection’ columns, and a fourth column titled ‘Operations.’ Check boxes can be selected to associate a feature with its corresponding catalog item (and ‘All/None buttons’ can toggle/un-toggle the immediate 50 check boxes). Above this table are pull downs that can filter items by Category/Type and Collection, and an ‘Associate’ button beneath the table applies the selections in the ‘Operations’ column.

The control center allows product providers to control which retailers can edit special product features in the product provider catalog.

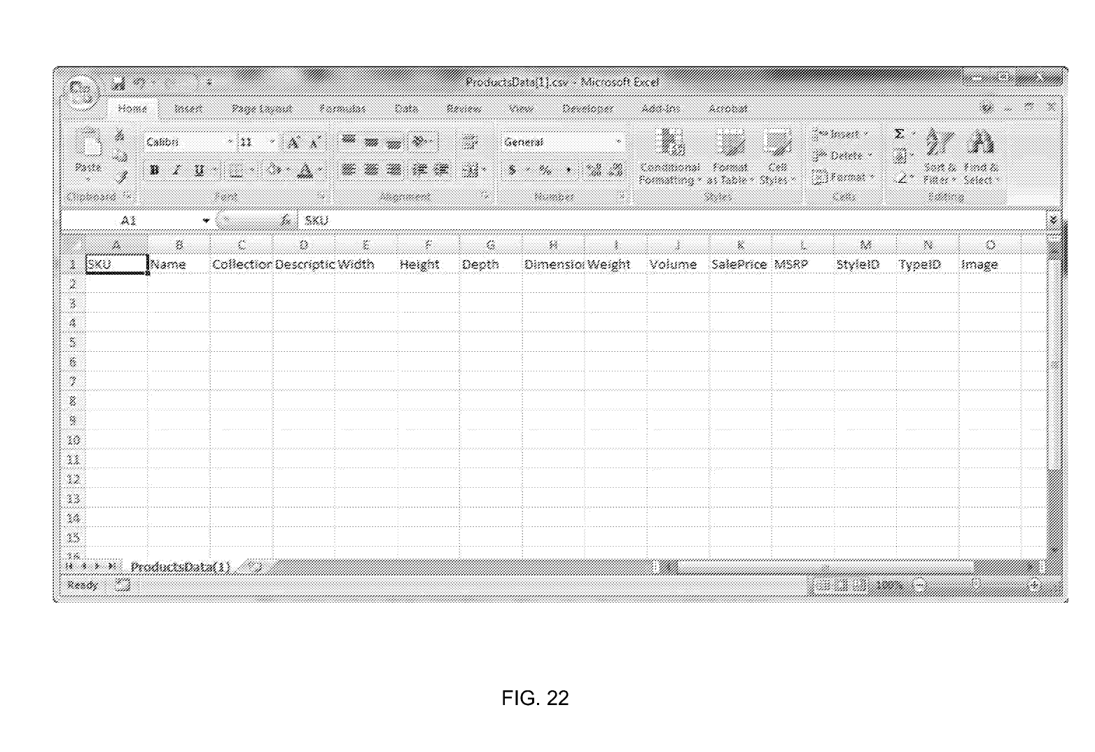

The control center allows product providers to easily load their product information in bulk. A user can copy product information from any spreadsheet to appropriate columns in a standard template, an example of which is shown in FIG. 22. The file can then be uploaded to the content management system. Images corresponding to the catalog items can be separately uploaded.

In some embodiments, the system hosts product provider websites. Product providers can use the system to populate dealer locator information on their websites by adding selected dealers from a predetermined list of dealers.

The processes of the retailer virtual store management system described above may be implemented in software, hardware, firmware, or any combination thereof. The processes are preferably implemented in one or more computer programs executing on a programmable computer including a processor, a storage medium readable by the processor (including, e.g., volatile and non-volatile memory and/or storage elements), and input and output devices. Each computer program can be a set of instructions (program code) in a code module resident in the random access memory of the computer. Until required by the computer, the set of instructions may be stored in another computer memory (e.g., in a hard disk drive, or in a removable memory such as an optical disk, external hard drive, memory card, or flash drive) or stored on another computer system and downloaded via the Internet or other network.

It is to be understood that although the invention has been described above in terms of particular embodiments, the foregoing embodiments are provided as illustrative only, and do not limit or define the scope of the invention. It should be apparent that modifications can be made without departing from the spirit and scope of the invention.

Having described preferred embodiments of the present invention, it should be apparent that modifications can be made without departing from the spirit and scope of the invention.

Method claims set forth below having steps that are numbered or designated by letters should not be considered to be necessarily limited to the particular order in which the steps are recited.

What is claimed is:

1. A computer-implemented method for managing retailer virtual stores for a plurality of retailers, each of the retailer virtual stores displaying products from one or more product providers available for sale to consumers, the method comprising the steps of:
receiving from each of the plurality of product providers data describing products available from the product provider;
receiving from each of the plurality of product providers or representatives of the product providers an indication as to whether a retailer has permission to display a given product from the product provider;
populating each of the retailer virtual stores with products selected by respective retailers and permitted to be displayed in the virtual store by product providers or representatives of the product providers; and
periodically receiving from product providers changes to data on their products, and automatically updating product data in retailer virtual stores reflecting the changes.

2. The method of claim 1, wherein the steps of the method are implemented in a server computer system, which communicates with client devices operated by product providers and retailers over the Internet.

3. The method of claim 1, wherein the retailer virtual stores are accessible by consumers through retailer websites.

4. The method of claim 1, wherein the product providers comprise manufacturers, distributors, or wholesalers of products.

5. The method of claim 1, further comprising collecting data on consumer activity in retailer virtual stores and providing the data to product providers.

6. The method of claim 5, wherein the consumer activity comprises buyer inquiries on products or views of products in a retailer virtual store.

7. The method of claim 5, wherein product providers are provided with data on consumer activity relating to their products across a plurality of retailers.

8. The method of claim 5, wherein product providers are provided with data on consumer activity relating to products across a plurality of product providers reflecting their respective market share of consumer activity.

9. The method of claim 1, further comprising enabling product providers to manage product warranties in retailer virtual stores relating to their respective products.

10. The method of claim 1, further comprising enabling product providers to manage product attributes of their respective products displayed in retailer virtual stores to facilitate searching of products by consumers.

11. The method of claim 1, further comprising enabling product providers to specify and manage relationships between their products displayed in retailer virtual stores.

12. The method of claim 1, further comprising providing data on consumer activity to retailer associations or to manufacturer consultants.

13. A retailer virtual store management system accessible by product providers over a communications network, comprising:
a plurality of retailer virtual stores, each provided to one of a plurality of retailers for displaying products from one or more product providers available for sale to consumers; and
a plurality of content management systems, each provided to one of the product providers for enabling the product provider or a representative of product provider to control which of its products can be displayed in which of the retailer virtual stores, the content management system also allowing the product provider to periodically provide product information changes, and to automatically update product data in retailer virtual stores reflecting the changes.

14. The system of claim 13, wherein the retailer virtual store management system is implemented in a server computer system, which communicates with client devices operated by product providers and retailers over the Internet.

15. The system of claim 13, wherein the retailer virtual stores are accessible by consumers through retailer websites.

16. The system of claim 13, wherein the product providers comprise manufacturers, distributors, or wholesalers of products.

17. The system of claim 13, wherein the content management systems allow product providers to access data on consumer activity in retailer virtual stores.

18. The system of claim 17, wherein the consumer activity comprises buyer inquiries on products or views of products in a retailer virtual store.

19. The system of claim 17, wherein product providers are provided with data on consumer activity relating to their products across a plurality of retailers.

20. The system of claim 17, wherein product providers are provided with data on consumer activity relating to products across a plurality of product providers reflecting their respective market share of consumer activity.

21. The system of claim 13, wherein the content management systems enable product providers to manage product warranties in retailer virtual stores relating to their respective products.

22. The system of claim 13, wherein the content management systems enable product providers to manage product attributes of their respective products displayed in retailer virtual stores to facilitate searching of products by consumers.

23. The system of claim 13, wherein the content management systems enable product providers to specify and manage relationships between their products displayed in retailer virtual stores.

24. The system of claim 13, wherein the retailer virtual store management system further provides data on consumer activity to retailer associations or to manufacturer consultants.

25. A computer-implemented method for operating retailer virtual stores for a plurality of retailers, each of the retailer virtual stores displaying products from one or more product providers available for sale to consumers, the method comprising the steps of:
receiving from each of the plurality of product providers data describing products available from the product provider;
populating each of the retailer virtual stores with products selected by respective retailers;
periodically receiving from product providers changes to data on their products, and automatically updating product data in retailer virtual stores reflecting the changes; and
collecting data on consumer activity in retailer virtual stores and providing the data to product providers.

26. The method of claim 25, wherein the consumer activity comprises buyer inquiries on products or views of products in a retailer virtual store.

27. The method of claim 25, wherein product providers are provided with data on consumer activity relating to their products across a plurality of retailers.

28. The method of claim 25, wherein product providers are provided with data on consumer activity relating to products across a plurality of product providers reflecting their respective market share of consumer activity.

29. The method of claim 25, wherein the steps of the method are implemented in a server computer system, which communicates with client devices operated by product providers and retailers over the Internet.

30. The method of claim 25, wherein the retailer virtual stores are accessible by consumers through retailer websites.

31. The method of claim 25, wherein the product providers comprise manufacturers, distributors, or wholesalers of products.

32. The method of claim 25, further comprising enabling product providers to manage product warranties in retailer virtual stores relating to their respective products.

33. The method of claim 25, further comprising enabling product providers to manage product attributes of their respective products displayed in retailer virtual stores to facilitate searching of products by consumers.

34. The method of claim 25, further comprising enabling each product provider or a representative of the product provider to control which of its products can be displayed in which of the retailer virtual stores.

35. The method of claim 25, further comprising enabling product providers to specify and manage relationships between their products displayed in retailer virtual stores.

36. The method of claim 25, further comprising providing data on consumer activity to retailer associations or to manufacturer consultants.

37. A retailer virtual store management system accessible by product providers over a communications network, comprising:
a plurality of retailer virtual stores, each provided to one of a plurality of retailers for displaying products from one or more product providers available for sale to consumers; and
a plurality of content management systems, each provided to one of the plurality of product providers for enabling product providers to manage data on their products in retailer virtual stores, the content management systems allowing product providers to periodically provide product information changes, and to automatically update product data in retailer virtual stores reflecting the changes, the content management systems also allowing product providers to access data on consumer activity in retailer virtual stores.

38. The system of claim 37, wherein the consumer activity comprises buyer inquiries on products or views of products in a retailer virtual store.

39. The system of claim 37, wherein product providers are provided with data on consumer activity relating to their products across a plurality of retailers.

40. The system of claim 37, wherein product providers are provided with data on consumer activity relating to products across a plurality of product providers reflecting their respective market share of consumer activity.

41. The system of claim 37, wherein the retailer virtual store management system is implemented in a server computer system, which communicates with client devices operated by product providers and retailers over the Internet.

42. The system of claim 37, wherein the retailer virtual stores are accessible by consumers through retailer websites.

43. The system of claim 37, wherein the product providers comprise manufacturers, distributors, or wholesalers of products.

44. The system of claim 37, wherein the content management systems enable product providers to manage product warranties in retailer virtual stores relating to their respective products.

45. The system of claim 37, wherein the content management systems enable product providers to manage product attributes of their respective products displayed in retailer virtual stores to facilitate searching of products by consumers.

46. The system of claim 37, wherein the content management systems allow product providers or representatives of product providers to control which of their products can be displayed in which retailer virtual stores.

47. The system of claim 37, wherein the content management systems enable product providers to specify and manage relationships between their products displayed in retailer virtual stores.

48. The system of claim 37, wherein the retailer virtual store management system further provides data on consumer activity to retailer associations or to manufacturer consultants.
